(19) United States
(12) Patent Application Publication
(10) Pub. No.: US 2006/0193413 A1
(43) Pub. Date: Aug. 31, 2006

(54) Method of capturing data transferred in synchronization with a data strobe signal and data capture circuit performing same

(75) Inventors: Prasenjit Shandilya, Yongin-si (KR); Yong-In Han, Seongnam-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/340,946

(22) Filed: Jan. 26, 2006

(30) Foreign Application Priority Data
Feb. 11, 2005 (KR) 2005-11514

(51) Int. Cl. H04L 7/00

(52) U.S. Cl. 375/355

(57) ABSTRACT

A method of capturing data that are transferred in synchronization with a data strobe signal. The method includes sampling a data strobe signal at a clock frequency higher than a data rate to detect a transition point of the data strobe signal (e.g., by generating and comparing a plurality of sampled data strobe signals), and sampling data to generate sampled data, and selecting reliable data among the sampled data based upon the transition point. A data capture circuit that captures data transferred in synchronization with a data strobe signal, includes a data strobe signal sampling circuit, a data sampling circuit, and may further include a transition position-indicating signal (case) generator and a data selection circuit. Accordingly, the method and the data capture circuit may effectively capture the data transferred in synchronization with the data strobe signal without employing or including a DLL on the chip.

### CLAIM FOR PRIORITY

This application claims priority under 35 USC §119 of Korean Patent Application No. 2005-11514 filed on Feb. 11, 2005 in the Korean Intellectual Property Office, the entire contents of which are hereby incorporated by reference.

### BACKGROUND OF THE INVENTION

1. Field of the Invention

The present invention relates to a data capture circuit. More particularly, the present invention relates to a method of capturing data that are transferred in synchronization with a data strobe signal and a data capture circuit for performing the same.

2. Description of the Related Art

Generally, a synchronous semiconductor memory device operates in response to an external clock during an input/output operation. The synchronous semiconductor memory device such as a double data rate (DDR) synchronous semiconductor memory device enables a memory interface device to effectively capture read data from a semiconductor memory device using a data strobe signal.

A memory interface device such as a memory controller captures data outputted from the synchronous semiconductor memory device using the data strobe signal. The data strobe signal is maintained at a high impedance state while the semiconductor memory device does not output data to the memory interface device.

While the semiconductor memory device outputs data, the data strobe signal is toggled from a logic ‘high’ (voltage) state to the logic ‘low’ (voltage) state or toggled from the logic ‘low’ state to the logic ‘high’ state at a timing when data has been outputted from the semiconductor memory device and another data begins to be outputted. The data strobe signal may have a preamble region (before the data strobe signal is toggled), and the data strobe signal may have a postamble region (after the data strobe signal has been toggled).

FIG. 1 is a timing diagram illustrating a data strobe signal according to the related art.

Referring to FIG. 1, the data strobe signal DQS has the preamble region 110 corresponding to one cycle of an external clock signal CLK before data are outputted, and then, the data strobe signal DQS is toggled for each new data.

FIG. 1 shows a read operation of a double data rate (DDR) semiconductor memory device that outputs two data (e.g., D1 and D2) during one cycle of the external clock signal CLK. One I/O pin sequentially outputs four bits of data D1, D2, D3 and D4 in response to a read command since a burst length corresponds to 4.

It is required that the memory interface device, such as the memory controller, capture data at the most stable timing using the data strobe signal DQS, so that the memory interface device may read data from the semiconductor memory device without errors.

FIG. 2 is a block diagram illustrating a connection relationship between a memory interface device and a semiconductor memory device according to the related art.

Referring to FIG. 2, the semiconductor memory device 210 performs I/O operations in response to an external clock CLK received from the memory interface device 220. The semiconductor memory device 210 outputs data DQ synchronously with the data strobe signal DQS.

The memory interface device 220 generates a local clock CLK (i.e., transmits the external clock CLK) to provide the local clock CLK to the semiconductor memory device 210. The memory interface device 220 generates a capture signal SA using the data strobe signal DQS provided from the semiconductor memory device 210 during the read operation, and then, the memory interface device 220 captures the data DQ provided from the semiconductor memory device 210 using the capture signal SA.

The memory interface device 220 shown in FIG. 2 captures the data DQ in response to the capture signal SA. The capture signal SA is generated by delaying the data strobe signal DQS (e.g., generated by delaying the data strobe signal DQS by 90 degrees). For example, the data DQ may be captured at a rising edge of the capture signal SA.

However, the conventional method of capturing data has a limitation in that the memory interface device 220 should generate the capture signal SA by using the data strobe signal DQS having a delay time that varies depending upon a clock frequency of the semiconductor memory device 210. Thus, when the semiconductor memory device 210 operates at the clock frequency of about 200 MHz, the capture signal SA should be generated by delaying the data strobe signal DQS by 1.25 ns. In addition, when the semiconductor memory device 210 operates at the clock frequency of about 400 MHz, the capture signal SA should be generated by delaying the data strobe signal DQS by 0.625 ns.

For generating the capture signal SA by delaying the data strobe signal DQS, a delay locked loop (DLL) is required. However, since the DLL is included in the memory interface device 220, implementation complexity of the memory interface device 220 is increased and its chip size may be increased.

Accordingly, it is required that the method of capturing data and the data capture circuit be capable of effectively capturing data transferred in synchronization with the data strobe signal, regardless of the clock frequency of the external clock applied to the semiconductor memory device 210, without using a DLL.

### SUMMARY OF THE INVENTION

Some embodiments of the present invention provide a method of effectively capturing data that are transferred in synchronization with a data strobe signal, without requiring the presence or use of a DLL.

Other embodiments of the present invention provide a data capture circuit that may effectively capture data transferred in synchronization with a data strobe signal without requiring the presence or use of a DLL.

An aspect of the invention provides a method of capturing data, the data being transferred at a data rate in synchronization with a data strobe signal, the method comprising: detecting a transition point of the data strobe signal (e.g., by sampling the data strobe signal at a first sampling frequency higher than the data rate, e.g., at four times the data rate) and sampling the data within a valid-data window, the valid-data window securing a predetermined timing margin away from the detected transition point of the data strobe signal. The predetermined timing margin may based upon the first sampling clock frequency higher than the data rate (e.g., two sample periods after the detected transition point).

Another aspect of the invention provides a method of capturing data, the data being transferred at a data rate in synchronization with a data strobe signal, the method comprising: generating sampled data strobe signals by sampling a data strobe signal at a first sampling frequency higher than the data rate. The sampled data strobe signals are compared to detect a transition point of the data strobe signal. The data is sampled (e.g., at a second sampling frequency), within a valid-data window, the valid-data window securing a predetermined timing margin away from the detected transition point of the data strobe signal. The first sampling frequency may be equal to the second sampling frequency, or equal to the data rate, or higher than the data rate. The first sampling frequency is more than twice the data rate, and is preferably at least four times the data rate. If the first sampling frequency is equal to the second sampling frequency, (or otherwise greater than the data rate), reliable data samples are selected among the sampled data based upon the valid-data window (based upon the sampled data strobe signals).

In some embodiments of the present invention, a method of capturing data transferred in synchronization with a data strobe signal includes: generating sampled data strobe signals by sampling a data strobe signal at a clock frequency higher than the data rate. Then sampled data are generated by sampling the data. The data may be sampled at the data rate, or in synchronization with when the data strobe signal is sampled (e.g., sampling the data strobe signal at the same time as, simultaneously, or in syncopation with sampling of the data). If the data is sampled at a rate higher than the data rate, then reliable data is selected among the sampled data based upon the sampled data strobe signals.

Selecting the reliable data may include determining a transition point of the data strobe signal (e.g., by comparing adjacent pairs of the sampled data strobe signals), and/or selecting the reliable data by sampling the data with a sufficient timing margin away from the transition point of the data strobe signal.

The data may be read from a semiconductor memory device, and the semiconductor memory device may include a double data rate (DDR) synchronous semiconductor memory device. Thus, the data strobe signal and the data may be output from the DDR synchronous semiconductor memory device.

In addition, the method may further comprise synchronizing the selected reliable data with a local clock. The local clock may be applied to the semiconductor memory device. In the case of a DDR synchronous semiconductor memory device, the frequency of the local clock may be a ½ data rate of the semiconductor memory device.

In other embodiments, selecting the reliable data may correspond to selecting the reliable data by using the sampled data strobe signals during a burst read operation of the semiconductor memory device for only the first read data in a burst mode, and selecting the reliable data based on a timing corresponding to the first read data for the read data excepting for the first read data in the burst mode. For example, in case of a burst read command having a burst length 4, the sampled data strobe signals are used when the first data in the burst mode is selected, and the data based on the timing corresponding to the first data are output when the second, third and fourth data are selected.

The data strobe signal (and the data) may be sampled four times during one data period. One data period refers to the time duration when one data is output through one data pin. For example, in case of a DDR synchronous semiconductor memory device, one data period corresponds to a ½ cycle (½ the period) of the local clock that is applied to the semiconductor memory device.

In some embodiments, the data strobe signal (and the data) may be sampled eight times during one cycle of the local clock (e.g., by using a sampling clock and a delayed sampling clock, in which the sampling clock has a clock frequency equal to the data rate and the delayed sampling clock is generated by delaying the sampling clock). The sampling clock may have the same frequency as the data rate, and the data may be sampled at the same frequency as the data rate while the data strobe signal is sampled at four times the data rate. Thus, in case of a DDR synchronous semiconductor memory device, the sampling clock has double the frequency of the local clock that is applied to the semiconductor memory device (because the data rate is twice the frequency of the local clock). The delayed sampling clock may be generated by delaying the sampling clock by 90 degrees or less than 90 degrees. The data strobe signal (and the data) may be sampled at rising edges and falling edges of the sampling clock and at rising edges and falling edges of the delayed sampling clock.

In some embodiments of the present invention, a data capture circuit is provided, in which the data is transferred in synchronization with a data strobe signal. The circuit includes a data strobe signal sampling circuit, and a data sampling circuit. The circuit may further include a transition position-indicating (case) signal generator, and a data selection circuit. The data strobe signal sampling circuit outputs sampled data strobe signals by sampling a data strobe signal at a sampling frequency higher than the data rate. The data sampling circuit outputs sampled data by sampling the data at the data rate, or in synchronization with (e.g., at the same time as, simultaneously, or in syncopation with) when the data strobe signal is sampled. The case signal generator generates a transition position-indicating (“case”) signal based upon the sampled data strobe signals. The case signal indicates the position of a transition (toggle) point of the data strobe signal, and the data selection circuit selects reliable data (where the data is sampled at a rate higher than the data rate) by selecting the data samples sampled within a valid-data window based upon the case signal. The valid-data window secures a sufficient timing margin away from the transition (toggle) point of the data strobe signal. The data selection circuit may synchronize the selected data with a local clock, and the data may be read out from the semiconductor memory device. In addition, semiconductor memory device may be or may include a double data rate (DDR) synchronous semiconductor memory device.

In further embodiments, the data selection circuit selects the reliable data samples by using the sampled data strobe signals during a burst read operation of the semiconductor memory device for only the first read data in a burst mode, and selects the reliable data based on a timing corresponding to the first read data for the read data other than the first read data in the burst mode.

The data strobe signal sampling circuit (and the data sampling circuit) may sample the data strobe signal (and the data) eight times during one cycle of the local clock (e.g., by using a sampling clock and a delayed sampling clock, where the sampling clock has a clock frequency equal to the data rate and the delayed sampling clock is generated by delaying the sampling clock). The data strobe signal sampling circuit and the data sampling circuit may respectively include a first flip-flop to which the sampling clock is applied, a second flip-flop to which an inverted signal of the sampling clock is applied, a third flip-flop to which the delayed sampling clock is applied, and a fourth flip-flop to which an inverted signal of the delayed sampling clock is applied. The data sampling circuit may allow the transition position-indicating (case) signal generator to generate the case signal by using the sampled data strobe signals and by employing a pipeline operation.

Therefore, the data transferred with the data strobe signal may be stably captured without a complex circuit such as a DLL circuit.

Detailed illustrative embodiments of the present invention are disclosed in the figures and description below. However, specific structural and functional details disclosed in the figures are merely representative for purposes of describing exemplary embodiments of the present invention. This invention may, however, be embodied in many alternate forms and should not be construed as limited to the exemplary embodiments set forth herein.

Accordingly, while the invention is susceptible to various modifications and alternative forms, specific embodiments thereof are shown by way of example in the drawings and will herein be described in detail. It should be understood, however, that there is no intent to limit the invention to the particular forms disclosed, but on the contrary, the invention is to cover all modifications, equivalents, and alternatives falling within the spirit and scope of the invention.

It will be understood that, although the terms first, second, etc. may be used herein to describe various elements, these terms are used only to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g.., “between” versus “directly between”, “driven by” versus “driven directly by”, “adjacent” versus “directly adjacent”, etc.).

The terminology used herein is for the purpose of describing particular embodiments and is not intended to be limiting of the invention. As used herein, the singular forms “a”, “an” and “the” are intended to include the plural forms as well, unless the context clearly indicates otherwise. It will be further understood that the terms “comprises”, “comprising”, “includes” and/or “including”, when used herein, specify the presence of stated features, integers, steps, operations, elements, and/or components, but do not preclude the presence or addition of one or more of the same or other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

It should also be noted that in some alternative implementations, the functions/acts noted in the blocks may occur out of the order indicated in the flowcharts. For example, two blocks shown in succession may in fact be executed substantially concurrently or the blocks may sometimes be executed in the reverse order, depending upon the functionality/acts involved.

### BRIEF DESCRIPTION OF THE DRAWINGS

The above and other features and advantages of the present invention will become more apparent when described in detailed embodiments thereof with reference to the attached drawings in which:

FIG. 1 is a timing diagram illustrating a data strobe signal according to the related art;

FIG. 2 is a block diagram illustrating a connection relationship between a conventional memory interface device and a conventional semiconductor memory device;

FIG. 3 is a flowchart for explaining a method of capturing data according to an exemplary embodiment of the present invention;

FIG. 4 is a timing diagram for explaining a method of capturing data transferred in synchronization with a data strobe signal according to an exemplary embodiment of the present invention;

FIGS. 5 through 8 are timing diagrams illustrating CASE1 through CASE4 shown in FIG. 4;

FIG. 9 is a block diagram illustrating a data capture circuit capturing data transferred in synchronization with a data strobe signal according to an exemplary embodiment of the present invention;

FIG. 10 is a block diagram illustrating a data strobe signal sampling circuit 910 shown in FIG. 9;

FIG. 11 is a block diagram illustrating a data sampling circuit 920 shown in FIG. 9; and

FIGS. 12 through 14 are block diagrams illustrating a data selection circuit shown in FIG. 9.

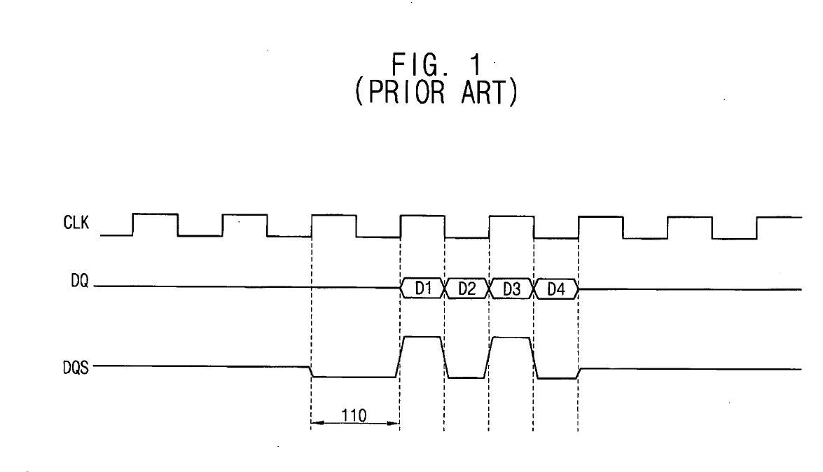

### DESCRIPTION OF THE EMBODIMENTS

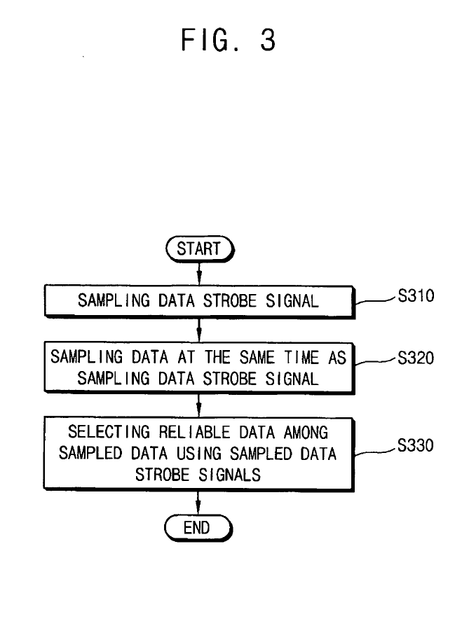

FIG. 3 is a flowchart for explaining a method of capturing data according to an exemplary embodiment of the present invention.

Referring to FIG. 3, the method includes a step of sampling a data strobe signal DQS at a (sampling) frequency higher than the data rate (the data rate of the data DQ) and generating sampled data strobe signals (step S310).

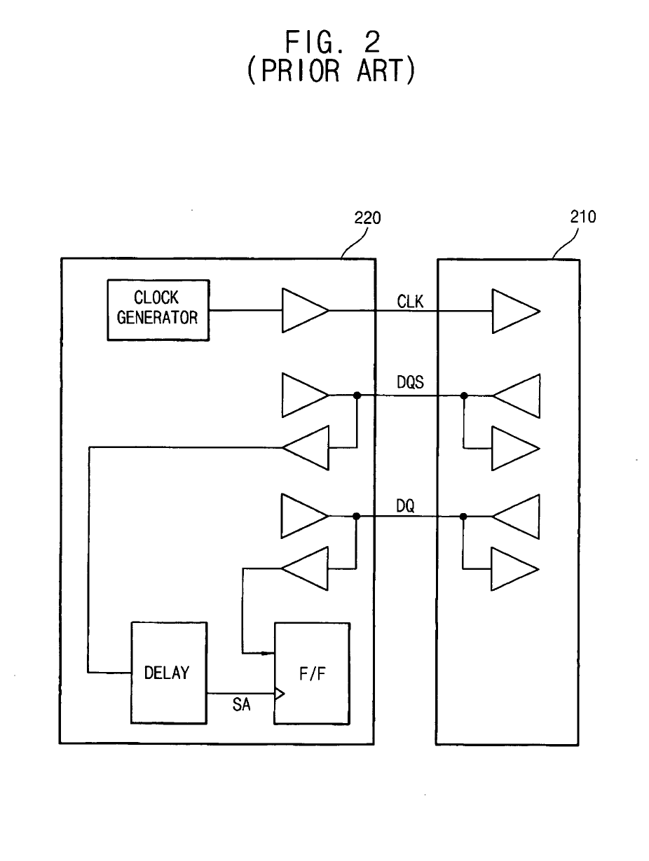

For example, the data rate may be two times higher than the frequency of a local clock (CLK in FIG. 2) applied to a double data rate (DDR) synchronous semiconductor memory device when the data are read data outputted from the semiconductor memory device (e.g., 210 of FIG. 2).

For example, the method may sample the data strobe signal eight times during one cycle of the local clock (CLK) applied to the DDR synchronous semiconductor memory device (e.g., 210 of FIG. 2).

The method includes a step of sampling data (S320) in synchronization with (e.g., at the same time as, simultaneously, or in syncopation with) the sampling of the data strobe signal (S310) and generating sampled data (step S320).

The process of sampling the data is performed in synchronization with (e.g., at the same time as, simultaneously, or in syncopation with) the process of sampling the data strobe signal. For example, the method may sample the data strobe signal and the data eight times during one cycle of the local clock applied to the DDR synchronous semiconductor memory device.

The method includes a step selecting reliable data among the sampled data using the sampled data strobe signal (step S330).

Here, the step of selecting the reliable data includes a step of determining a “transition point” (toggle point) of the data strobe signal by using the sampled data strobe signals, and a step of selecting the “reliable data sample” among the sampled data. The “reliable data sample” refers to a data sample in an identified valid-data window. The valid-data window refers to a region where a sufficient timing margin away from the transition point of the data strobe signal is secured.

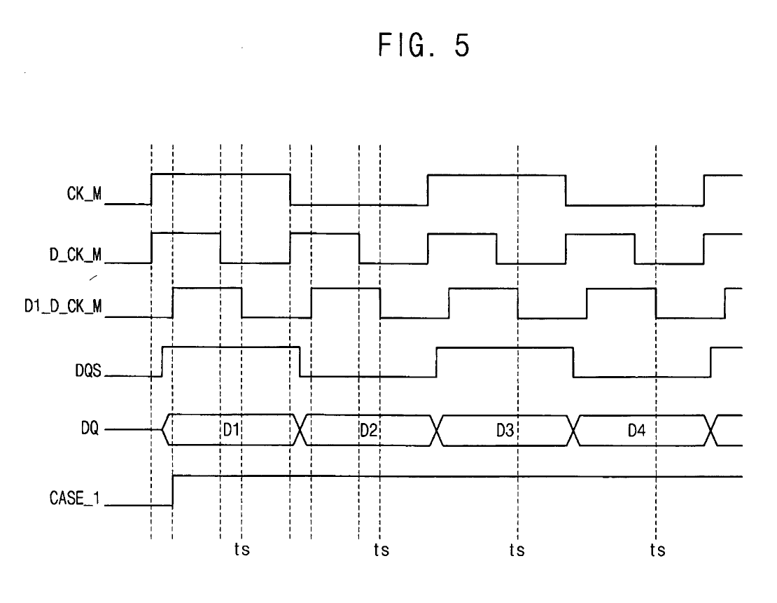

The transition point of the data strobe signal DQS may be understood as follows. When samples of the data strobe signal DQS have different logic states at respective rising edges of the sampling clock and the delayed (next) sampling clock, the data strobe signal DQS may be considered as undergoing a state transition, (e.g., from a logic low state to a logic high state, or vice versa). The detailed description of the transition (toggle) point of the data strobe signal DQS will be given with respect to FIGS. 5 through 8.

The method may effectively and reliably capture the data transferred in synchronization with the data strobe signal by selecting a reliable data sample within the valid-data window.

The sampled data may be selected (as a reliable data sample) at a stable timing when the sampling frequency of the data strobe signal and the data is high relative to the local clock (CLK). In particular, each of the data strobe signal and the data may be sampled four times or more for one data cycle, and thus each of the data strobe signal and the data may be sampled eight times or more for one period of the local clock CLK.

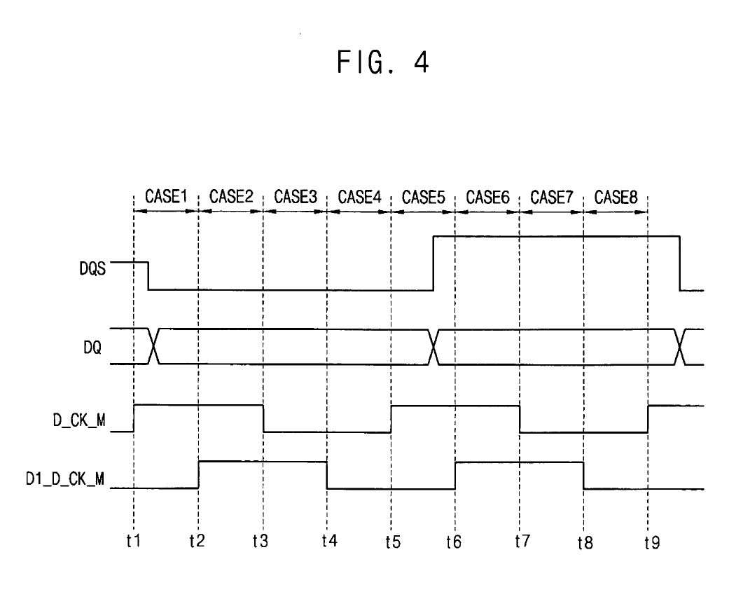

FIG. 4 is a timing diagram for explaining a method of capturing data transferred in synchronization with a data strobe signal according to an exemplary embodiment of the present invention.

Referring to FIG. 4, the data strobe signal DQS and the data DQ are sampled four times during one data cycle (i.e., eight times for one period of the local clock CLK). Each of the reference symbols ‘t1’ through ‘t9’ represent a sampling timing when both the data strobe signal DQS and the data DQ are sampled (e.g., simultaneously sampled).

The reference symbols ‘CASE1’ through “CASE 8” are synchronized with the sampling times ‘t1’ through ‘t9’ and are correlated with the time intervals between consecutive samples among sampling times ‘t1’ through ‘t9’.

In general: The reference symbol ‘CASE1’ represents that the data strobe signal DQS experiences a state transition (e.g., low to high) during the time interval between consecutive samples ‘t1’ and ‘t2’; The reference symbol ‘CASE2’ represents that the data strobe signal DQS experiences the state transition during the time interval between consecutive samples ‘t2’ and ‘t3’; The reference symbol ‘CASE3’ represents that the data strobe signal DQS experiences the state transition during the time interval between consecutive samples ‘t3’ and ‘t4’; The reference symbol ‘CASE4’ represents that the data strobe signal DQS experiences the state transition during the time interval between consecutive samples ‘t4’ and ‘t5’; The reference symbol ‘CASE5’ represents that the data strobe signal DQS experiences the state transition during the time interval between consecutive samples ‘t5’ and ‘t6’; The reference symbol ‘CASE6’ represents that the data strobe signal DQS experiences the state transition during the time interval between consecutive samples ‘t6’ and ‘t7’; The reference symbol ‘CASE7’ represents that the data strobe signal DQS experiences the state transition during the time interval between consecutive samples ‘t7’ and ‘t8’; and The reference symbol ‘CASE8’ represents that the data strobe signal DQS experiences the state transition during the time interval between consecutive samples ‘t8’ and ‘t9’. In the example shown in FIG. 4, because the data strobe signal DQS experiences the (e.g., low to high) state transition during the time interval between consecutive samples ‘t5’ and ‘t6’, the transition (toggle) point detected shown in FIG. 4 corresponds to the reference symbol ‘CASE5’.

In an another example, where transition (toggle) point detected corresponds to the reference symbol ‘CASE1’ (representing that the data strobe signal DQS experiences the (low to high) state transition during the time interval between consecutive samples ‘t1’ and ‘t2’, the method of capturing the data transferred in synchronization with the data strobe signal DQS selects the other data samples sampled at the sampling time ‘t4’ and the sampling time ‘t8’ as “reliable data samples”. The reason for selecting the data samples (e.g., at sampling times ‘t4’ and ‘t8’) taken at sample times other than those corresponding to when the data strobe signal DQS experiences the (low to high) state transition (e.g., ‘t1’ and ‘t2’ in ‘CASE1’) is that a setup time and a hold time of the data DQ are secured at the sampling time ‘t4’ and the sampling time ‘t8’, and thus, the data DQ may be stably captured (sampled) at those times.

In case of reference symbol ‘CASE2’ representing that the data strobe signal DQS experiences the (low to high) state transition during the time interval between consecutive samples ‘t2’ and ‘t3’, the method of capturing the data transferred in synchronization with the data strobe signal DQS selects the data samples sampled at the sampling time ‘t5’ and the sampling time ‘t9’ as “reliable data samples”. The reason for selecting the data is that the setup time and the hold time of the data DQ are secured at the sampling timing ‘t5’ and the sampling timing ‘t9’, and thus, the data DQ may be stably captured.

Similarly: In case of reference symbol ‘CASE3’ representing that the data strobe signal DQS experiences the (low to high) state transition during the time interval between consecutive samples ‘t3’ and ‘t4’, the method of capturing the data transferred in synchronization with the data strobe signal DQS selects the data sampled at the sampling timing ‘t6’ as a “reliable data sample”; and In case of reference symbol ‘CASE4’ representing that the data strobe signal DQS experiences the (low to high) state transition during the time interval between consecutive samples ‘t4’ and ‘t5’, the method of capturing the data transferred in synchronization with the data strobe signal DQS selects the data sampled at the sampling timing ‘t7’ a “reliable data sample”.

The ‘CASE5’, ‘CASE6’, ‘CASE7’ and ‘CASE8’are correlated with the ‘CASE1’, ‘CASE2’, ‘CASE3’ and ‘CASE4’, respectively.

Referring back to FIG. 4, in order to sample the data strobe signal DQS and the data DQ four times during one data cycle, the sampling clock D_CK_M (having a clock frequency identical with the data rate, e.g., double the local clock CLK) and the delayed sampling clock D1_D_CK_M (also having a clock frequency identical with the data rate) are used. It is preferable that the delayed sampling clock D1_D_CK_M be generated by delaying the sampling clock D_CK_M by 90 degrees.

The method of capturing the data DQ transferred in synchronization with the data strobe signal DQS includes sampling the data strobe signal DQS and the data DQ at each rising edge and each falling edge of the sampling clock D_CK_M, and at each rising edge and each falling edge of the delayed sampling clock D1_D_CK_M.

Thus, the sampling times ‘t1’, ‘t5’ and ‘t9’ (e.g., ‘t9’ is ‘t1’, repeated) correspond to the rising edges of the sampling clock D_CK_M; The sampling timings ‘t2’ and ‘t6’ correspond to the rising edges of the delayed sampling clock D1_D_CK_M; The sampling times ‘t3’ and ‘t7’ correspond to the falling edges of the sampling clock D_CK_M; and, The sampling times ‘t4’ and ‘t8’ correspond to the falling edges of the delayed sampling clock D1_D_CK_M.

When the frequency of the sampling clock D_CK_M is identical with the data rate, the data strobe signal DQS and the data DQ may be sampled four times during one data cycle using the sampling clock D_CK_M and the delayed sampling clock D1_D_CK_M. It is easy to implement the delayed sampling clock D1_D_CK_M since it is not necessary to precisely set the delay time t_{d} of the delayed sampling clock D1_D_CK_M relative to the sampling clock D_CK_M.

TABLE 1

| | | | | | | | | | | DATA SAMPLING |
|---|---|---|---|---|---|---|---|---|---|---|
| | t1 | t2 | t3 | t4 | t5 | t6 | t7 | t8 | t9 | TIMING |
| CASE 1 | 0 | 1 | X | X | X | X | X | X | X | FALLING EDGE |
| | | | | | | | | | | OF D1 D CK M |
| CASE 2 | 0 | 0 | 1 | X | X | X | X | X | X | RISING EDGE OF |
| | | | | | | | | | | D CK M |
| CASE 3 | 0 | 0 | 0 | 1 | X | X | X | X | X | RISING EDGE |
| | | | | | | | | | | OF D1 D CK M |
| CASE 4 | 0 | 0 | 0 | 0 | 1 | X | X | X | X | FALLING EDGE |
| | | | | | | | | | | OF D CK M |
| CASE 5 | 0 | 0 | 0 | 0 | 0 | 1 | X | X | X | FALLING EDGE |
| | | | | | | | | | | OF D1 D CK M |
| CASE 6 | 0 | 0 | 0 | 0 | 0 | 0 | 1 | X | X | RISING EDGE |
| | | | | | | | | | | OF D CK M |
| CASE 7 | 0 | 0 | 0 | 0 | 0 | 0 | 0 | 1 | X | RISING EDGE |
| | | | | | | | | | | OF D1 D CK M |
| CASE 8 | 0 | 0 | 0 | 0 | 0 | 0 | 0 | 0 | 1 | FALLING EDGE |
| | | | | | | | | | | OF D CK M |

Table 1 is a table summarizing the timing diagram described in FIG. 4.

Referring to Table 1, the reference symbols ‘CASE1’ through ‘CASE8’ and the sampling times ‘t1’ through ‘t9’ correspond to the timing diagram shown in FIG. 4.

The symbol ‘0’ shown in Table 1 represents a logic ‘0’ state of the sample of the data strobe signal DQS, the symbol ‘1’ shown in Table 1 represents a logic ‘1’ state of the sample of the data strobe signal DQS and the symbol ‘X’ shown in Table 1 represents a “Don't Care” state (i.e., a state that need not to be considered) of the sample of the data strobe signal DQS.

FIGS. 5 through 8 are timing diagrams illustrating CASE1 through CASE4 shown in FIG. 4.

FIG. 5 is a timing diagram illustrating CASE1 shown in FIG. 4.

Referring to FIG. 5, the sampling clock D_CK_M has a clock frequency two times higher than that of the local clock CK_M. The local clock CK_M may be a clock applied to the semiconductor memory device, (or, the local clock CK_M may be generated by dividing the sampling clock D_CK_M by 2). The delayed sampling clock D1_D_CK_M may be generated by delaying the sampling clock D_CK_M, and it is preferable that the delayed sampling clock D1_D_CK_M be generated by delaying the sampling clock by 90 degrees or within (less than) 90 degrees.

The process of sampling the data DQ is sequentially performed by sampling the data DQ at the rising edge of the sampling clock D_CK_M, at the rising edge of the delayed sampling clock D1_D_CK_M, at the falling edge of the sampling clock D_CK_M and at the falling edge of the delayed sampling clock D1_D_CK_M.

As shown in FIG. 5, illustrating CASE1, the data strobe signal DQS is at the logic ‘0’ state at the first rising edge of the sampling clock D_CK_M, and the data strobe signal DQS is at the logic ‘1’ state at the first rising edge of the delayed sampling clock D1_D_CK_M. Therefore, as described in FIG. 4 and Table 1, the timing diagram shown in FIG. 5 corresponds to the ‘CASE1’, and a first case signal CASE_1 is activated to indicate that the timing diagram shown in FIG. 5 corresponds to the ‘CASE1’. Thereafter the data samples sampled at the periodic sampling times ‘ts’ (e.g., correlated with the falling edges of the delayed sampling clock D1_D_CK_M) are selected, suitable data (the “reliable data samples”) may be captured.

In particular, when a burst read operation of the semiconductor memory device is performed, the suitable (“reliable”) periodic sampling time ‘ts’ for the data D1 may be selected (by sampling the data strobe signal DQS as above described), and thereafter, other (“reliable”) burst data D2, D3 and D4 may be selected at the reliable periodic sampling times ‘ts’.

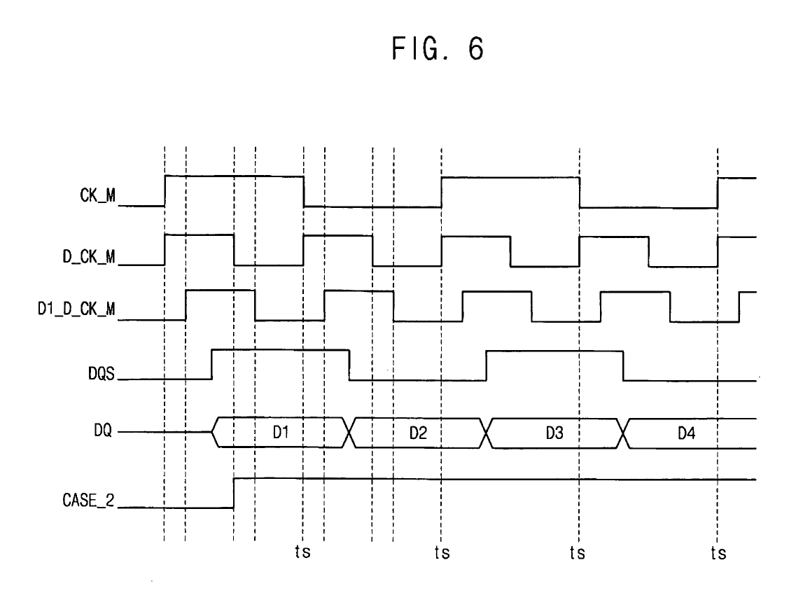

FIG. 6 is a timing diagram illustrating CASE2 shown in FIG. 4.

As shown in FIG. 6, the data strobe signal DQS is at the logic ‘0’ at the first rising edge of the delayed sampling clock D1_D_CK_M, and the data strobe signal DQS is at the logic ‘1’ at the first falling edge of the sampling clock D_CK_M. Therefore, as described in FIG. 4 and Table 1, the timing diagram shown in FIG. 6 corresponds to the ‘CASE2’, and a second case signal CASE_2 is activated to indicate that the timing diagram shown in FIG. 6 corresponds to the ‘CASE2’. Thereafter, the data samples sampled at the “reliable” periodic sampling times ‘ts’ (e.g., correlated with the rising edges of the sampling clock D_CK_M) are selected, suitable data (“reliable data samples”) may be captured.

In particular, when a burst read operation of the semiconductor memory device is performed, the suitable periodic sampling times ‘ts’ for sampling the data D1 may be selected (by using the sampled data strobe signal, i.e., by sampling the data strobe signal DQS) and thereafter, other burst data D2, D3 and D4 may be selected (by periodically sampling the data) at the selected “reliable” periodic sampling times ‘ts’.

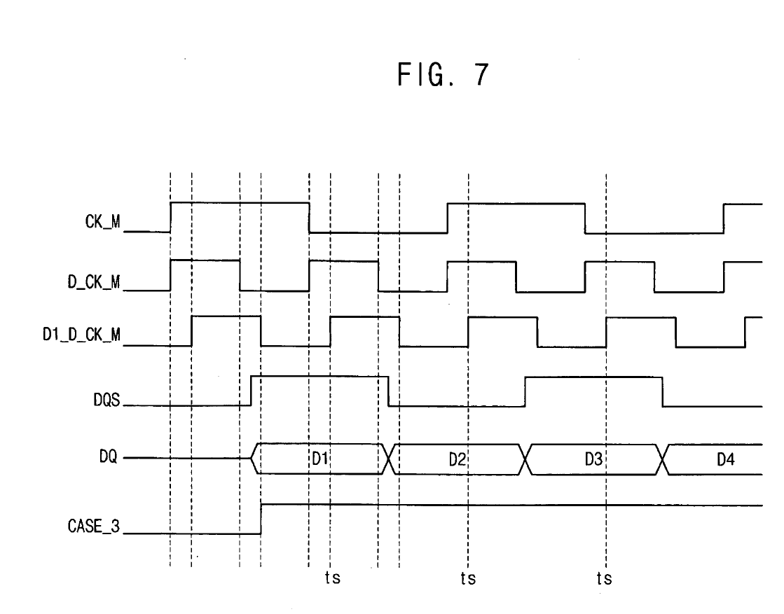

FIG. 7 is a timing diagram illustrating CASE3 shown in FIG. 4.

As shown in FIG. 7, the data strobe signal DQS is at the logic ‘0’ at the first falling edge of the sampling clock D_CK_M, and the data strobe signal DQS is at the logic ‘1’ at the first falling edge of the delayed sampling clock D1_D_CK_M. Therefore, as described in FIG. 4 and Table 1, the timing diagram shown in FIG. 7 corresponds to the ‘CASE3’, and a third case signal CASE_3 is activated so that the timing diagram shown in FIG. 7 corresponds to the ‘CASE3’. Thereafter, when the data sampled at the “reliable” periodic sampling times ‘ts’ (e.g., at the rising edge ‘ts’ of the delayed sampling clock D1_D_CK_M) are selected, suitable data (“reliable data samples”) may be captured.

In particular, when a burst read operation of the semiconductor memory device is performed, the suitable (“reliable) periodic sampling timing ‘ts’ for the data D1 may be selected using (based on) the sampled data strobe signal, and then, other burst data D2, D3 and D4 may be determined by sampling at the periodic sampling times ‘ts’.

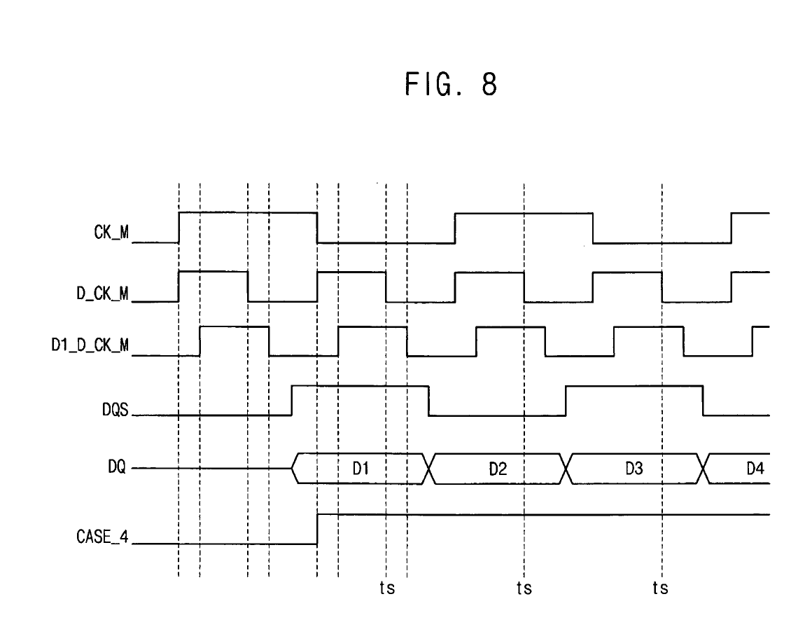

FIG. 8 is a timing diagram illustrating CASE4 shown in FIG. 4.

As shown in FIG. 8, the data strobe signal DQS is at the logic ‘0’ at the first falling edge of the delayed sampling clock D1_D_CK_M, and the data strobe signal DQS is at the logic ‘1’ at the second rising edge of the sampling clock D_CK_M. Therefore, as described in FIG. 4 and Table 1, the timing diagram shown in FIG. 8 corresponds to the ‘CASE4’, and a fourth case signal CASE_4 is activated so that the timing diagram shown in FIG. 8 corresponds to the ‘CASE4’. Thereafter, when the data samples sampled at the “reliable” periodic sampling times ‘ts’ (e.g., at the falling edge of the sampling clock D_CK_M) are selected, suitable data (“reliable data samples”) may be captured.

In particular, when a burst read operation of the semiconductor memory device is performed, the suitable periodic sampling times ‘ts’ for the data D1 may be selected using (based on) the sampled data strobe signal, and thereafter, other burst data D2, D3 and D4 may be determined by sampling at the periodic sampling times ‘ts’.

The ‘CASE5’, ‘CASE6’, ‘CASE7’ and ‘CASE8’ correspond to ‘CASE1’, ‘CASE2’, ‘CASE3’ and ‘CASE4’ described with reference to FIGS. 5 through 8, respectively.

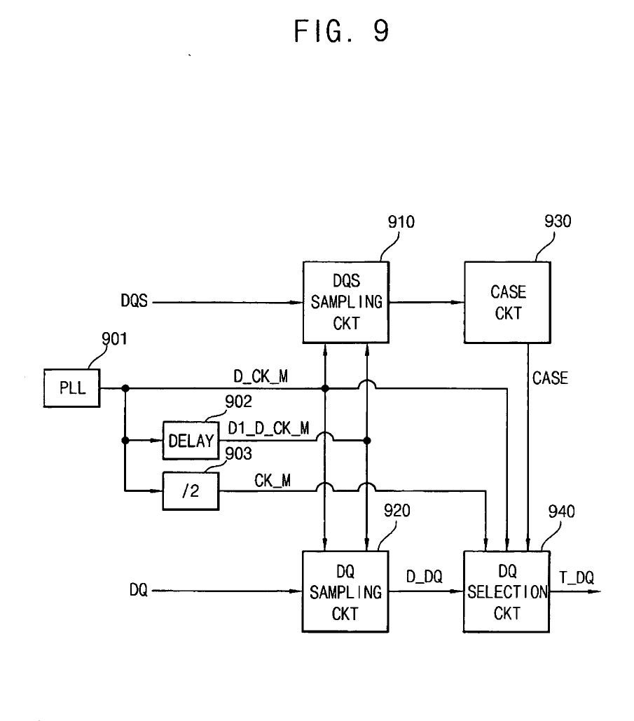

FIG. 9 is a block diagram illustrating a data capture circuit configured to capture data transferred in synchronization with a data strobe signal according to an exemplary embodiment of the present invention.

Referring to FIG. 9, the data capture circuit includes a data strobe signal sampling circuit 910, a data sampling circuit 920, a case signal generator 930 and a data selection circuit 940. Additionally, the data capture circuit may include a phase locked loop (PLL) 901, a delay circuit 902 and a divider 903.

The PLL 901 generates the sampling clock D_CK_M. The sampling clock D_CK_M has a frequency the same as the data rate of the data to be captured.

The delay circuit 902 delays the sampling clock D_CK_M to generate the delayed sampling clock D1_D_CK_M. It is preferable that the delay circuit 902 delays the sampling clock D_CK_M by 90 degrees or less than 90 degrees.

The divider 903 divides the sampling clock D_CK_M by two to generate the local clock CK_M. The local clock CK_M may be applied to the semiconductor memory device.

The data strobe signal sampling circuit 910 samples the data strobe signal DQS to generate samples of the data strobe signal. The data strobe signal sampling circuit 910 samples the data strobe signal DQS eight times during one cycle of the local clock CK_M. The data strobe signal sampling circuit 910 samples the data strobe signal DQS using the sampling clock D_CK_M and the delayed sampling clock D1_D_CK_M. Because the sampling clock D_CK_M has the clock frequency two times higher than that of the local clock CK_M, when the data strobe signal DQS is sampled at the rising edge and the falling edge of the sampling clock D_CK_M and at the rising edge and the falling edge of the delayed sampling clock D1_D_CK_M, the data strobe signal DQS may be sampled eight times during one cycle (period) of the local clock CK_M.

The data sampling circuit 920 samples the data DQ to generate samples D_DQ of the data DQ. The data sampling circuit 920 samples the data eight times during one cycle (period) of the local clock CK_M.

The data sampling circuit 920 samples the data DQ using the sampling clock D_CK_M and the delayed sampling clock D1_D_CK_M. Because the sampling clock D_CK_M has a frequency two times higher than that of the local clock CK_M, when the data DQ are sampled at the rising edge and the falling edge of the sampling clock D_CK_M and at the delayed sampling clock D1_D_CK_M, the data DQ is sampled eight times during one cycle (period) of the local clock CK_M.

The case signal generator 930 generates a case signal CASE indicating the position of a transition (toggle) point of the data strobe signal DQS (e.g., relative to the sampling clock D_CK_M). The case signal CASE indicates one of the 8 CASEs CASE1 through CASE8. The output of the case signal generator 930 as characterized in FIG. 4 and in Table 2 (below), and the case signal generator 930 generates the case signal CASE based on the sampled data strobe signals. For example, the case signal CASE may be a digital signal composed of 8 bits, where each bit encodes one of CASE_1 through CASE_8 indicating the CASE1 through CASE8, or may be a signal composed of 3 bits. The following Table 2 is a table summarizing operations of the case signal generator 930.

TABLE 2

| | t1 | t2 | t3 | t4 | t5 | t6 | t7 | t8 | t9 | OPERATION |
|---|---|---|---|---|---|---|---|---|---|---|
| CASE 1 | 0 | 1 | X | X | X | X | X | X | X | CASE_1 |
| | | | | | | | | | | ACTIVATED |
| CASE 2 | 0 | 0 | 1 | X | X | X | X | X | X | CASE_2 |
| | | | | | | | | | | ACTIVATED |
| CASE 3 | 0 | 0 | 0 | 1 | X | X | X | X | X | CASE_3 |
| | | | | | | | | | | ACTIVATED |
| CASE 4 | 0 | 0 | 0 | 0 | 1 | X | X | X | X | CASE_4 |
| | | | | | | | | | | ACTIVATED |
| CASE 5 | 0 | 0 | 0 | 0 | 0 | 1 | X | X | X | CASE_5 |
| | | | | | | | | | | ACTIVATED |
| CASE 6 | 0 | 0 | 0 | 0 | 0 | 0 | 1 | X | X | CASE_6 |
| | | | | | | | | | | ACTIVATED |
| CASE 7 | 0 | 0 | 0 | 0 | 0 | 0 | 0 | 1 | X | CASE_7 |
| | | | | | | | | | | ACTIVATED |
| CASE 8 | 0 | 0 | 0 | 0 | 0 | 0 | 0 | 0 | 1 | CASE_8 |
| | | | | | | | | | | ACTIVATED |

Referring to Table 2, each of CASE_1 through CASE_8 are signals indicating one of CASE1 through CASE8.

The data selection circuit 940 selects “reliable” data (e.g., a “reliable data sample”) among the sampled data using the case signal CASE indicating the position of the transition point of the data strobe signal DQS (e.g., relative to the sampling clock D_CK_M). The reliable data sample refers to data sample sampled in a valid-data window (e.g., indicated by the case signal CASE). The valid-data window refers to a region where a sufficient timing margin away from the transition (toggle) point is secured.

The data selection circuit 940 may select and output two samples of data DQ since the data sampling circuit 920 samples the data DQ during one cycle of the local clock CK_M. Because a double data rate (DDR) synchronous semiconductor memory device outputs two data during one cycle of the local clock CK_M, the data capture circuit may sample each of the data four times and then select two samples among the sampled data.

The data selection circuit 940 may synchronize the selected data samples with the local clock CK_M, latch and output the selected data samples as reliable data T_DQ.

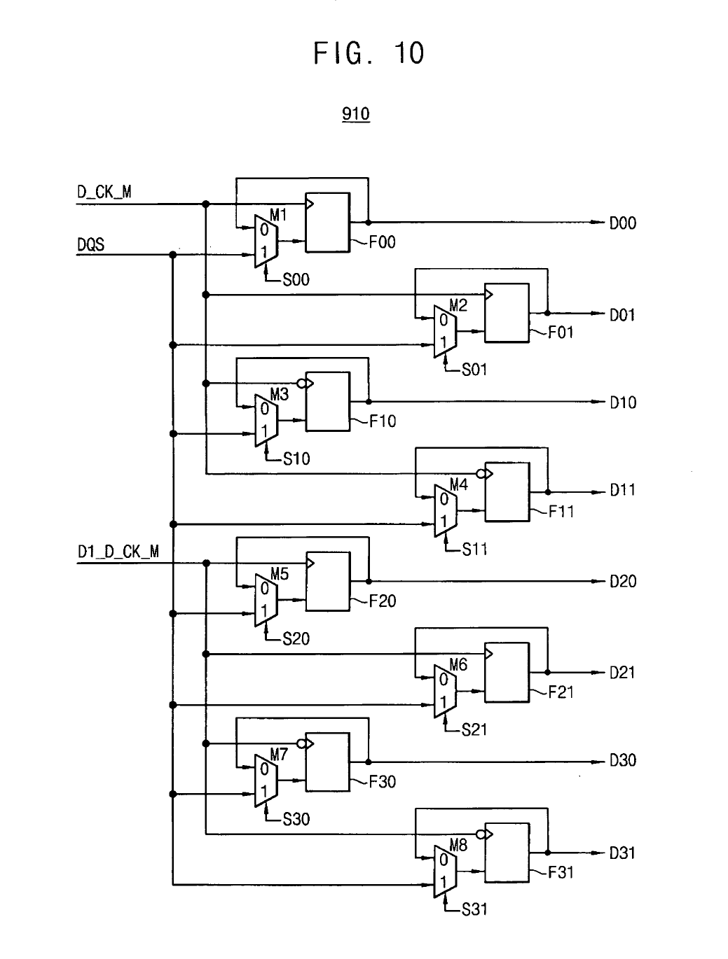

FIG. 10 is a block diagram illustrating the data strobe signal sampling circuit 910 shown in FIG. 9.

Referring to FIG. 10, the data strobe signal sampling circuit 910 includes a plurality of flip-flops F00, F01, F10, F11, F20, F21, F30 and F31, and equal plurality of MUXes M1 through M8.

Each of the MUXes M1 through M8 outputs one of two mux-inputs based on an applied sampling control signal (one of S00, S01, S10, S11, S20, S21, S30, S31, respectively).

The flip-flop F00 samples the data strobe signal DQS at a first rising edge of the sampling clock D_CK_M to output a sampled data strobe signal D00. The sampled data strobe signal D00 is the sample of the data strobe signal DQS taken at the sampling time ‘t1’ (relative to the sampling clock D_CK_M) shown in FIG. 4.

The flip-flop F20 samples the data strobe signal DQS at a first rising edge of the delayed sampling clock D1_D_CK_M to output a sampled data strobe signal D 20. The sampled data strobe signal D 20 is the sample of the data strobe signal DQS taken at the sampling time ‘t2’ shown in FIG. 4.

The flip-flop F10 samples the data strobe signal DQS at a first falling edge of the sampling clock D_CK_M to output a sampled data strobe signal D10. The sampled data strobe signal D10 is the sample of the data strobe signal DQS taken at the sampling time ‘t3’ shown in FIG. 4.

The flip-flop F30 samples the data strobe signal DQS at a first falling edge of the delayed sampling clock D1_D_CK_M to output a sampled data strobe signal D30. The sampled data strobe signal D30 is the sample of the data strobe signal DQS taken at the sampling time ‘t4’ shown in FIG. 4.

The flip-flop F01 samples the data strobe signal DQS at a second rising edge of the sampling clock D_CK_M to output the sampled data strobe signal D01. The sampled data strobe signal D01 is the sample of the data strobe signal DQS taken at the sampling time ‘t5’ shown in FIG. 4.

The flip-flop F21 samples the data strobe signal DQS at a second rising edge of the delayed sampling clock D1_D_CK_M to output the sampled data strobe signal D21. The sampled data strobe signal D21 is the sample of the data strobe signal DQS taken at the sampling time ‘t6’ shown in FIG. 4.

The flip-flop F11 samples the data strobe signal DQS at a second falling edge of the sampling clock D_CK_M to output the sampled data strobe signal D11. The sampled data strobe signal D1 1 is the sample of the data strobe signal DQS taken at the sampling time ‘t7’ shown in FIG. 4.

The flip-flop F31 samples the data strobe signal DQS at a second falling edge of the delayed sampling clock D1_D_CK_M to output the sampled data strobe signal D31. The sampled data strobe signal D31 is the sampled signal at the sampling time ‘t8’ shown in FIG. 4.

The flip-flops F00, F01, F10, F11, F20, F21, F30 and F31 sample the data strobe signal DQS at an appropriate sample timing (e.g., a uniform or non-periodic sampling rate) based on the sampling control signals S00, S01, S10, S11, S20, S21, S30 and S31. Additionally, the flip-flops F00, F01, F10, F11, F20, F21, F30 and F31 may sample the data strobe signal DQS at either the first phase of the sampling clock D_CK_M and the delayed sampling clock D1_D_CK_M or at a second phase of the sampling clock D_CK_M and the delayed sampling clock D1_D_CK_M, based on the sampling control signals S00, S01, S10, S11, S20, S21, S30 and S31.

The following ‘Table 3’ represents the sampling times of the data strobe signal DQS as shown in FIG. 10 corresponding to the sampling timing shown in FIG. 4.

TABLE 3

| SAMPLE | Sampled Data Strobe |
|---|---|
| TIME | Signal |
| t1 | D00 |
| t2 | D20 |
| t3 | D10 |
| t4 | D30 |
| t5 | D01 |
| t6 | D21 |
| t7 | D11 |
| t8 | D31 |

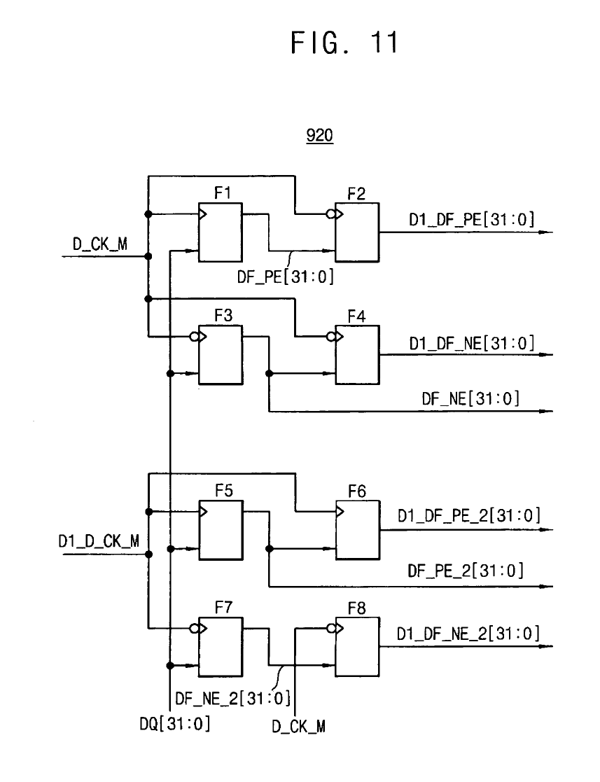

FIG. 11 is a block diagram illustrating a data sampling circuit 920 shown in FIG. 9.

Referring to FIG. 11, the data sampling circuit 920 includes a plurality of first stage flip-flops F1, F3, F5 and 7, and an equal plurality of second stage flip-flops F2, F4, F6 and F8.

The first stage flip-flops F1, F3, F5 and F7 sample the data DQ (e.g., DQ[31:0], composed of 32 bits) at a rising edge and a falling edge of each of the sampling clock D_CK_M and the delayed sampling clock D1_D_CM_M.

The second stage flip-flops F2, F4, F6 and F8 re-sample the data sampled and output by the first stage flip-flops F1, F3, F5 and F7.

As described above, the case signal generator 930 may generate the case signal CASE indicating a sampling time period since the data sampling circuit 920 operates with a pipeline method.

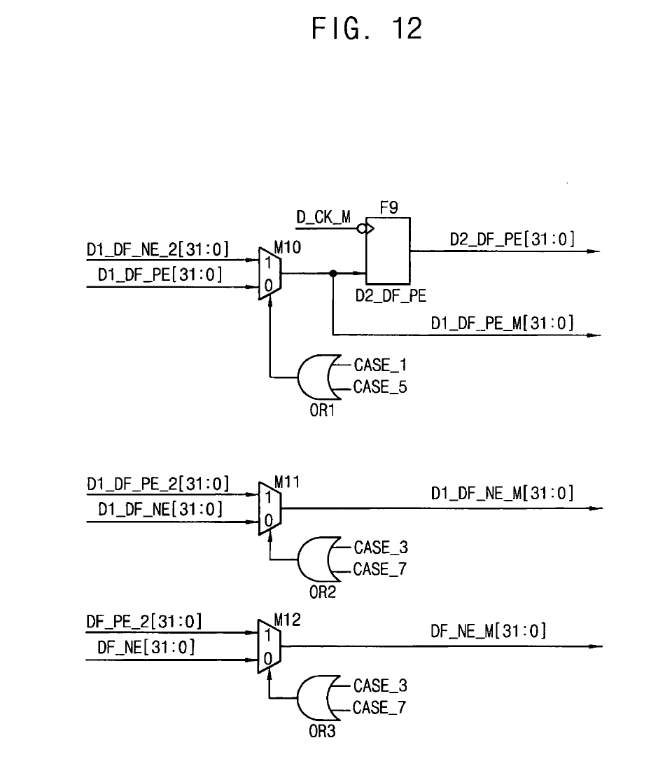

FIGS. 12 through 14 are block diagrams illustrating a data selection circuit 940 shown in FIG. 9.

In the block diagram shown in FIG. 12, the CASE2 or the CASE6 shown in FIG. 4 is processed by the MUX M1 0, and the CASE4 or the CASE8 is processed by the MUXes M11 and M12. Referring to FIG. 12, a MUX M10 selects the data D1_DF_NE_2[31:0] corresponding to the falling edge of the delayed sampling clock D1_D_CK_M in case of the CASE1 or the CASE5, and the MUX M10 selects the data D1_DF_PE[31:0] corresponding to the rising edge of the sampling clock D_CKIM in cases other than that of the CASE1 or the CASE5.

A flip-flop F9 samples the data D1_DF_PE_M[31:0] selected by the MUX M10 at the falling edge of the sampling clock D_CK_M to output the sampled data D2 _DF_PE[31:0].

A MUX M11 select(s) the data D1_DF_PE_2[31:0] corresponding to the rising edge of the delayed sampling clock D1_D_CK_M in case of the CASE3 or the CASE7, and select(s) the data D1_DF_NE[31:0] corresponding to the falling edge of the sampling clock D_CK_M in cases other than that of the CASE3 or the CASE7.

A MUX M12 select(s) the data DF_PE_2[31:0] corresponding to the rising edge of the delayed sampling clock D 1 _D_CK_M in case of the CASE3 or the CASE7, and select(s) the data DF_NE[31:0] corresponding to the falling edge of the sampling clock D_CK_M in cases other than that of the CASE3 or the CASE7.

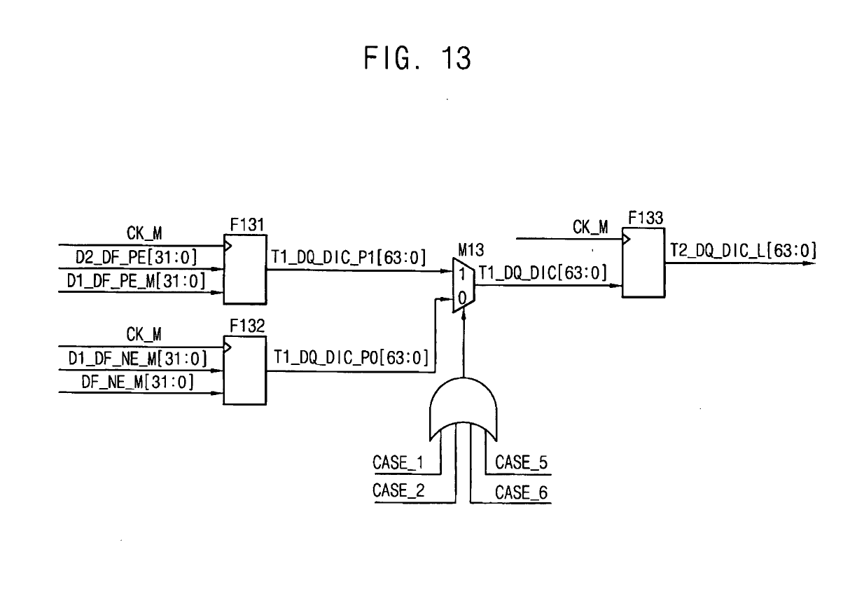

Referring to FIG. 13, a flip-flop F131 samples the data D 2 _DF_PE[31:0] and D1_DF_PE_M[31:0] corresponding to the falling edge of the sampling clock D_CK_M or the delayed sampling clock D1_D_CK_M to generate 64-bit data T1_DQ_DIC_P1[63:0] corresponding to the rising edge of the sampling clock D_CK_M or the falling edge of the delayed sampling clock D1_D_CK_M. The 64-bit data T1_DQ_DIC-P1[63:0] are the sum of consecutive two 32-bit data corresponding to the rising edge of the sampling clock D_CK_M or the falling edge of the delayed sampling clock D1_D_CK_M.

A flip-flop F132 samples the data D1_DF_NE_M[31:0] and DV_NE_M[31:0] corresponding to the falling edge of the sampling clock D_CK_M or the rising edge of the delayed sampling clock D1_D_CK_M to generate 64-bit data T1_DQ_DIC_P0[63:0] corresponding to the falling edge of the sampling clock D_CK_M or the rising edge of the delayed sampling clock D1_D_CK_M. The 64-bit data T1_DQ_DIC_P0[63:0] are the sum of consecutive two 32-bit data corresponding to the rising edge of the sampling clock D_CK_M or the falling edge of the delayed sampling clock D1_D_CK_M.

A MUX M13 selects one of the 64-bit data T1_DQ_DICP1[63:0] or T1_DQ_DIC_P0[63:0]. Thus, the MUX M13 selects the 64-bit data T1_DQ_DIC_P1[63:0] in case of the CASE1, CASE2, CASE5 and CASE6, and selects the 64-bit data T1_DQ_DIC_P0[63:0] in cases other than those of CASE1, CASE2, CASE5 and CASE6.

A flip-flop F133 samples the 64-bit data T1_DQ_DIC_{—}[63:0] at the rising edge of the local clock CK_M to output the sampled 64-bit data T2_DQ_DIC_L[63:0].

The 64-bit data T1_DQ_DIC[63:0] is the sum of consecutive 32-bit data sampled in a valid-data window securing a sufficient timing margin away from the transition (toggle) point of the data strobe signal DQS. The 64-bit data T2_DQ_DIC_L[63:0] may be the previous data of the 64-bit data T1_DQ_DIC[63:0] by one cycle of the local clock CK_M.

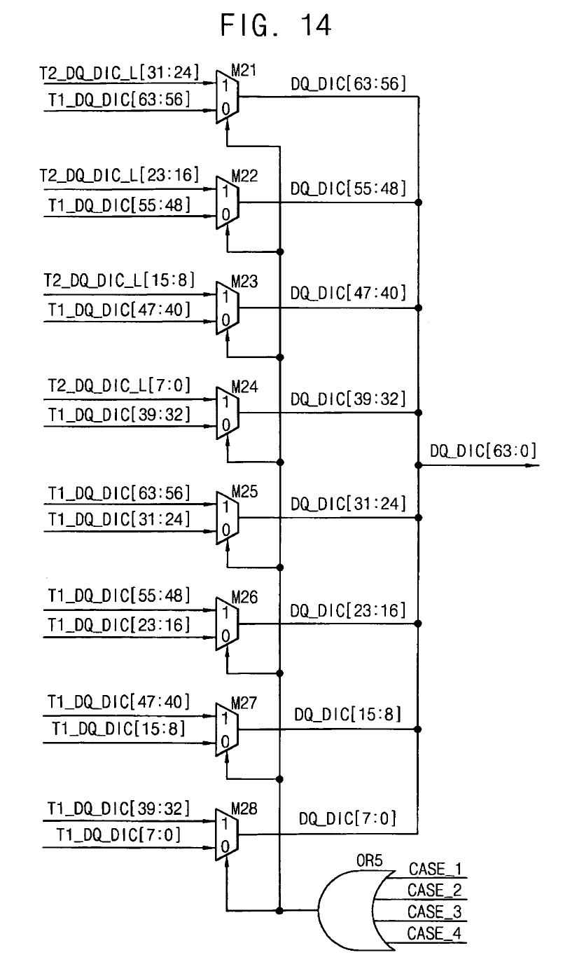

Referring to FIG. 14, in case of the CASE1, CASE2, CASE3 or CASE4 shown in FIG. 4, the higher 32-bit data of the 64-bit data T1_DQ_DIC[63:0] and the lower 32-bit data of the 64-bit data T2_DQ_DIC_L[63:0] are selected. In case of the CASE5, CASE6, CASE7 and CASE8 shown in FIG. 4, all of the 64-bit data T1_DQ_DIC[63:0] are selected. The reason for selecting the 64-bit data is that a time interval between the CASE1 through CASE4 and the CASE5 through CASE8 is as much as half of one cycle of the local clock; thus, the reliable data may be selected at a suitable timing.

The last outputted 64-bit data DQ_DIC[63:0] are captured data of two 32-bit data outputted from the DDR synchronous semiconductor memory device during one cycle (period) of the local clock.

This invention may, however, be embodied in many alternate forms and should not be construed as limited to the embodiments set forth herein. The spirit of the present invention is not be limited to sampling the data strobe signal DQS and the data DQ using the sampling clock and the delayed sampling clock. Any sampling the data strobe signal DQS using a frequency higher than the data rate, or selecting the reliable data sample sampled in a valid-data window determined by detecting the transition(s) of the data strobe signal (e.g., by sampling the data strobe signals) are within the scope of the present invention.

In methods and circuits of capturing data transmitted with a data strobe signal according to some embodiments of the present invention, the data strobe signal and the data are sampled by using a frequency higher than the data rate, and the transition (toggle) point of the data strobe signal is determined by sampling the data strobe signal. The reliable data may be sampled at a stable timing. Therefore, data transmitted with a data strobe signal may be stably captured without a complex circuit such as a DLL etc.

While the exemplary embodiments of the present invention have been described in detail, it should be understood that various changes, substitutions and alterations may be made herein without departing from the scope of the invention.

What is claimed is:

1. A method of capturing data, the data being transferred at a data rate in synchronization with a data strobe signal, the method comprising:
sampling a data strobe signal at a first sampling frequency higher than the data rate.

2. The method of claim 1, further comprising detecting a transition point of the data strobe signal based upon the sampled data strobe signals.

3. The method of claim 1, further comprising:
sampling the data at a second sampling frequency.

4. The method of claim 3, wherein the first sampling frequency is equal to the second sampling frequency.

5. The method of claim 3, wherein the second sampling frequency is equal to the data rate.

6. The method of claim 3, wherein the first sampling frequency is more than twice the data rate.

7. The method of claim 3, wherein the second sampling frequency is higher than the data rate.

8. The method of claim 7, further comprising:
selecting a reliable data sample among the sampled data.

9. The method of claim 8, wherein the reliable data sample is selected based upon the sampled data strobe signals.

10. The method of claim 8, wherein selecting the reliable data sample comprises:
detecting a transition point of the data strobe signal based upon the sampled data strobe signals.

11. The method of claim 8, wherein selecting the reliable data sample comprises:
selecting a data sample in a valid-data window, the valid-data window securing a sufficient timing margin away from a transition point of the data strobe signal.

12. The method of claim 11, wherein the transition point of the data strobe signal is detected based upon the sampled data strobe signals.

13. The method of claim 8, further comprising:
synchronizing the selected reliable data sample with a local clock.

14. The method of claim 1, wherein the data are read from a semiconductor memory device.

15. The method of claim 14, wherein the semiconductor memory device includes a double data rate (DDR) synchronous semiconductor memory device.

16. The method of claim 15, wherein the reliable data sample is selected by detecting a transition point of the data strobe signal based upon the sampled data strobe signals during a burst read operation of the semiconductor memory device for only the first read data in a burst mode.

17. The method of claim 16, wherein the data strobe signal and the data are both sampled eight times during one period of the local clock.

18. The method of claim 1, wherein the data strobe signal is sampled by using a sampling clock and a delayed sampling clock, the sampling clock having a clock frequency equal to the data rate, the delayed sampling clock being generated by delaying the sampling clock.

19. The method of claim 18, wherein the delayed sampling clock is generated by delaying the sampling clock by 90 degrees or less than 90 degrees.

20. The method of claim 18, wherein the data strobe signal is sampled at rising edges and at falling edges of the sampling clock and at rising edges and at falling edges of the delayed sampling clock.

21. The method of claim 20, wherein the data strobe signal and the data are sampled simultaneously.

22. A method of capturing data, the data being transferred at a data rate in synchronization with a data strobe signal, the method comprising:
detecting a transition point of the data strobe signal; and
sampling the data within a valid-data window, the valid-data window securing a predetermined timing margin away from the detected transition point of the data strobe signal.

23. The method of claim 22, wherein detecting the transition point of the data strobe signal includes sampling the data strobe signal at a first sampling frequency higher than the data rate.

24. A data capture circuit, the data being transferred at a data rate in synchronization with a data strobe signals, comprising:
a data strobe signal sampling circuit configured to sample the data strobe signals at a first sampling rate higher than the data rate;and a data sampling circuit.

25. The data capture circuit of claim 24, wherein the data sampling circuit is configured to select reliable data by sampling the data within a valid-data window, the valid-data window securing a sufficient timing margin away from a transition point of the data strobe signal.

26. The data capture circuit of claim 25, wherein the selected reliable data is synchronized with a local clock.

27. The data capture circuit of claim 24, wherein the data are read from a semiconductor memory device.

28. The data capture circuit of claim 24, further comprising a case signal generator configured to generate a case signal based upon the sampled data strobe signals, the case signal indicating a transition point of the data strobe signal.
